(19) United States
(12) Patent Application Publication
(10) Pub. No.: US 2023/0200566 A1
(43) Pub. Date: Jun. 29, 2023

(54) FOLDABLE STAND FOR A SMART DEVICE

(71) Applicant: A STAND UP COMPANY PTY LTD, Somerton Park (AU)

(72) Inventors: Tyron CHEESMAN, Somerton Park (AU); Kirk CHEESMAN, Somerton Park (AU); Nicola CHEESMAN, Somerton Park (AU)

(21) Appl. No.: 18/145,255

(22) Filed: Dec. 22, 2022

(30) Foreign Application Priority Data
Dec. 23, 2021 (AU) 2021904219

(51) Int. Cl. A47F 5/11; H04M 1/04

(52) U.S. Cl. CPC A47F 5/112; H04M 1/04

(57) ABSTRACT

The card item is foldable into a smart device stand. The card item includes a panel body having a first fold line at a mid-portion thereof to define a first panel and a second panel. The first panel and the second panel each have a second fold line extending from a top edge and a cut line extending from the second fold line to an outer edge. In each of the first panel and the second panel, the second fold line, the cut line and a respective top corner define a tab section. The first panel can be folded towards the second panel, and the tab sections can be folded to reveal seat edges defined by the cut lines and backrest edges defined by the second fold lines.

### CROSS-REFERENCE TO RELATED APPLICATIONS

The present application claims priority under 35 U.S.C. Section 119 from Australian Patent Application No. 2021904219, filed on 23 Dec. 2021, entitled “CARD ITEM FOLDABLE INTO SMART DEVICE STAND”. See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to card items foldable into a smart device stand.

### 2. Description of Related Art Including Information Disclosed Under 37 CFR 1.97 and 37 CFR 1.98

Most budget airlines now do not provide entertainment screens. Passengers in these airlines are now used to this limit in the service and prepare by bringing their own entertainment via their smart device such as smartphones or tablets. A particular difficulty is that the tray tables in planes do not have a holder or stand for the user's smart device.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a card item foldable into a smart device stand, the card item comprising a panel body having a first fold line at a mid-portion thereof to define a first panel and a second panel,

the first panel and the second panel each having a second fold line extending from a top edge and a cut line extending from the second fold line to an outer edge,

wherein in each of the first panel and the second panel, the second fold line, the cut line and a respective top corner define a tab section,

wherein the first panel can be folded towards the second panel and the tab sections can be folded to reveal seat edges defined by the cut lines and backrest edges defined by the second fold lines.

In one embodiment, the tab sections are folded rearwardly.

In another embodiment, the tab sections are folded towards each other.

In another embodiment, the tab sections are connected to each other.

In another embodiment, the first panel and the second panel each have a respective third fold line to define inner panel sections and outer panel sections, the outer panel sections having the tab sections, wherein the outer panel sections are folded towards each other.

In another embodiment, the card item comprises a rectangular panel body having a top edge, bottom edge, side edges, top corners and bottom corners, and the first fold line extends vertically from the top edge to the bottom edge at a mid-portion thereof.

In another embodiment, the second fold line extends from about a mid-portion of the top edge of each of the first panel and the second panel, the second fold lines respectively extending downwardly and being angled generally towards the respective bottom corners of the first panel and the second panel, the second fold lines terminating at a cut point spaced from the bottom edge and the respective side edges of the first panel and the second panel.

In another embodiment, the cut lines extend from the cut point towards the respective side edge thereof, the cut lines being substantially perpendicular to their respective second fold line.

In another embodiment, the first panel can be folded to the second panel via the first fold line to a carry configuration of the card item.

In another embodiment, the third fold lines are disposed at respective mid-portions of the first panel and the second panel and extend vertically from the top edge to the bottom edge.

In another embodiment, each tab section includes a respective vertical slit cut disposed at an upper portion thereof and a top corner of the second panel can be inserted through the slit cut in the tab section of the first panel, and the top corner of the first panel can be inserted through the slit cut in the tab section of the second panel.

In another embodiment, the first panel and the second panel are generally square panels with rounded corners and the second fold line extends from close to the first fold line.

In another embodiment, the tab section of the first panel includes a vertical slit cut which is disposed at an upper portion thereof parallel to the side edge and spaced from the top edge, and the tab section of the second panel includes a slit cut extending from the top edge thereof and spaced from the top corner thereof to form a pivotable top corner portion.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a front view of an unfolded card item in accordance with a first preferred embodiment of the present invention showing the fold lines and cut lines thereof.

FIG. 2 is a side perspective view of the card item of FIG. 1 in first folded configuration thereof for carrying.

FIG. 3 is a front perspective view of the card item of FIG. 1 in an initial folded configuration there for use as a stand.

FIG. 4 is a front perspective view of the card item of FIG. 1 in a final folded configuration thereof for use as a stand.

FIG. 5 is a rear perspective view of the folded card item of FIG. 4 in use with a smartphone.

FIG. 6 is a front perspective view of the folded card item of FIG. 4 in use with a smartphone.

FIG. 7 is a front view of an unfolded card item in accordance with a second preferred embodiment of the present invention showing the fold lines and cut lines thereof.

FIG. 8 is a side perspective view of the card item of FIG. 7 in first folded configuration thereof for carrying.

FIG. 9 is a front perspective view of the card item of FIG. 7 in an initial folded configuration there for use as a stand.

FIG. 10 is a front perspective view of the card item of FIG. 7 in a final folded configuration thereof for use as a stand.

FIG. 11 is a rear perspective view of the folded card item of FIG. 7 in use with a smartphone.

FIG. 12 is a front perspective view of the folded card item of FIG. 7 in use with a smartphone.

FIG. 13 is a front view of an unfolded card item in accordance with a third preferred embodiment of the present invention showing the fold lines and cut lines thereof.

FIG. 14 is a side perspective view of the card item of FIG. 13 in first folded configuration thereof for carrying.

FIG. 15 is a front perspective view of the card item of FIG. 13 in an initial folded configuration there for use as a stand.

FIG. 16 is a front perspective view of the card item of FIG. 13 in a final folded configuration thereof for use as a stand.

FIG. 17 is a rear perspective view of the folded card item of FIG. 13 in use with a smartphone.

FIG. 18 is a front perspective view of the folded card item of FIG. 13 in use with a smartphone.

FIG. 19 is a front view of an unfolded card item in accordance with a fourth preferred embodiment of the present invention showing the fold lines and cut lines thereof.

FIG. 20 is a front perspective view of the card item of FIG. 19 in partially folded configuration thereof.

FIG. 21 is a front perspective view of the card item of FIG. 19 in a final folded configuration thereof for use as a stand.

FIG. 22 is a rear perspective view of the folded card item of FIG. 19 in use with a smartphone.

FIG. 23 is a front side perspective view of the folded card item of FIG. 19 in use with a smartphone.

FIG. 24 shows a card item according to a fifth preferred embodiment of the present invention.

### DETAILED DESCRIPTION OF THE INVENTION

It should be noted in the following description that like or the same reference numerals in different embodiments denote the same or similar features.

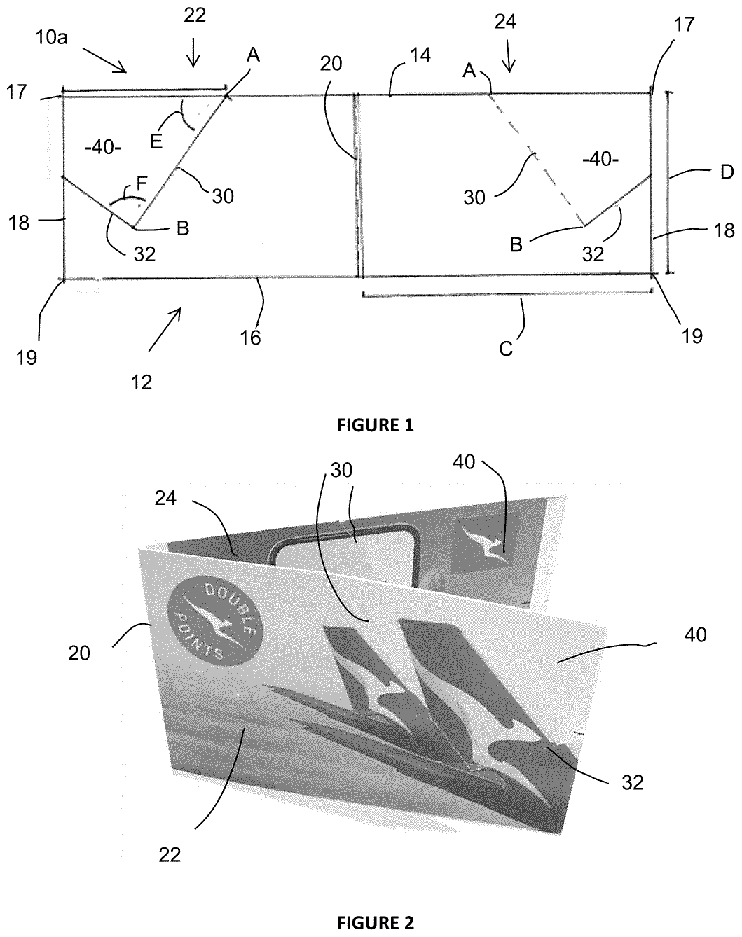

FIG. 1 shows a card item 10a according to a first preferred embodiment of the present invention. The card item 10a comprises an elongated rectangular panel body 12 having a top edge 14, bottom edge 16, side edges 18, top corners 17 and bottom corners 19. The body 12 has a first fold line 20 at a mid-portion thereof extending vertically from the top edge 14 to the bottom edge 16. The fold line 20 divides the body 12 into a first panel 22 and a second panel 24 which are thus both smaller rectangular panels.

The first panel 22 and the second panel 24 each have a second fold line 30 extending from point A being at about a mid-portion of the top edge 14 of each of the first panel 22 and the second panel 24, the second fold lines 30 respectively extending downwardly from Point A and being angled generally towards the respective bottom corners 19 of the first panel 22 and the second panel 24, but terminating at a point B spaced from the bottom edge 16 and the respective side edges 18 of the first panel 22 and the second panel 24.

The first panel 22 and the second panel 24 each have a cut line 32 extending from point B towards the respective side edge 18 thereof, the cut lines 32 being perpendicular to their respective second fold line 30. In each of the first panel 22 and the second panel 24, the second fold line 30, cut line 32 and the top corners 17, define therebetween a tab section 40.

As shown in FIG. 2, the first panel 22 can be folded to the second panel 24 via the first fold line 20 to the carry configuration of the card item 10a at which the folded card item 10a is the size of a typical business card.

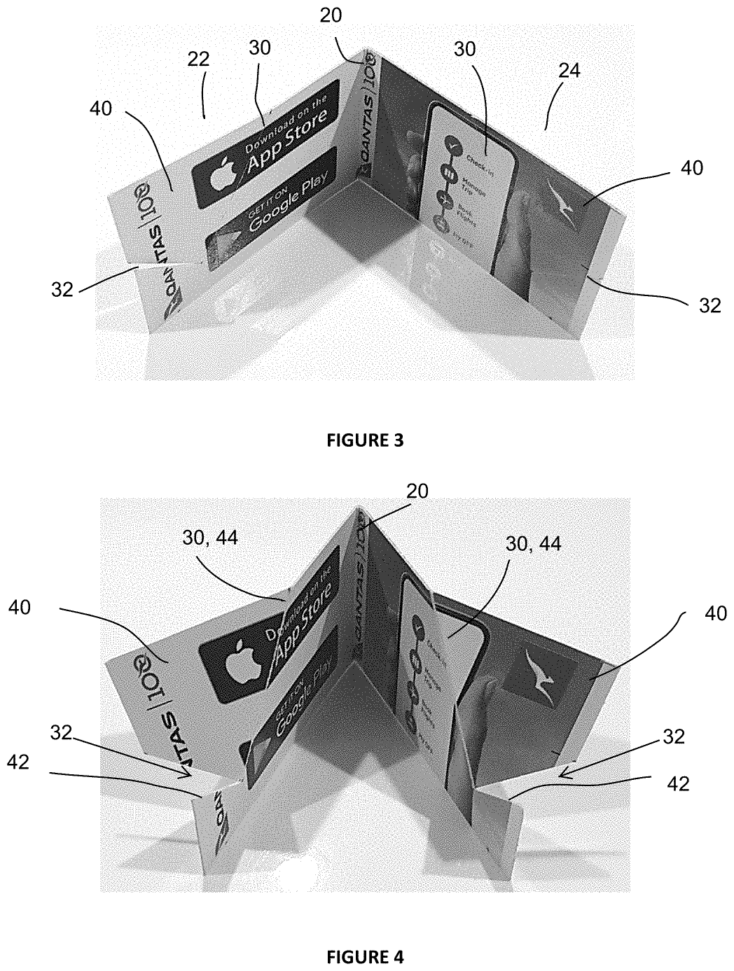

As shown in FIGS. 3 and 4, to form a smart device stand, the first panel 22 is moved to an angle of between 30° to 70° relative to the second panel 24. The tab sections 40 are then folded rearwardly to reveal seat edges 42 defined by the cut lines 32, and backrest edges 44 defined by the second fold lines 30.

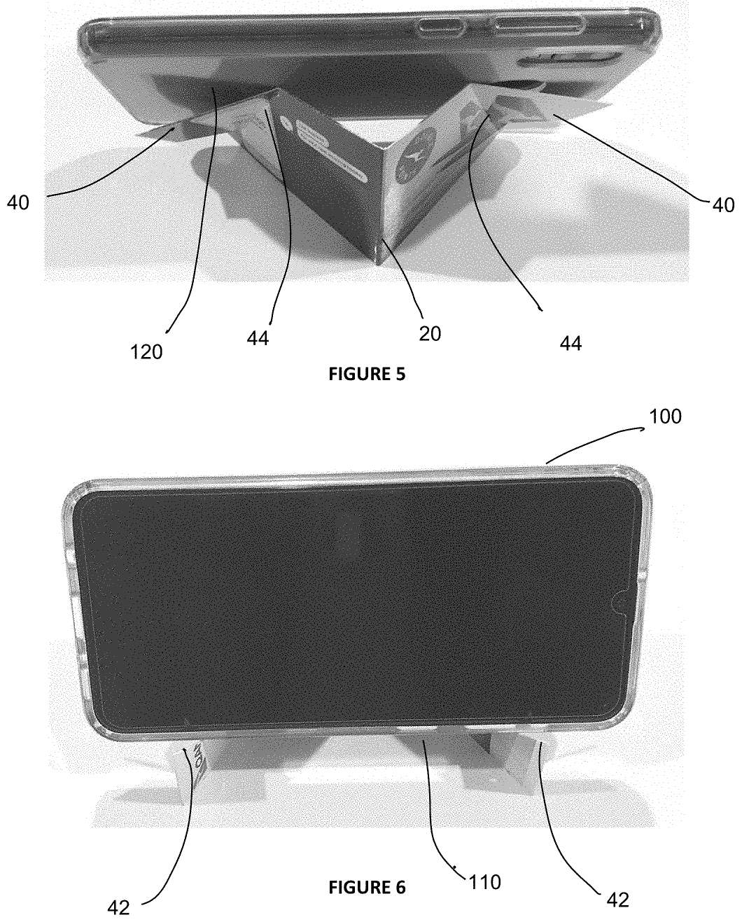

As shown in FIGS. 5 and 6, an edge 110 of a smartphone 100 can then be placed onto the seat edges 42, with the back 120 of the smartphone 110 resting on the backrest edges 44. As the second fold lines 30 are angled, the card item 10a folded into the stand configuration thereof holds the smartphone 100 at a desired angled position.

The card item 10a in the example can be made from carboard, laminated cardboard, plastics material, metal, or other suitable card item material. In the example shown, the first panel 22 and the second panel 24 are each 90 mm in length C and 55 mm in height D. Point A is 50 mm from the top corners 17, second fold line 30 is 50 mm in length at a 55° angle E relative to the top edge 14, cut line 32 is at 90° angle F relative to the second fold line 30. These dimensions are examples only and the card item 10a is not limited to these dimensions.

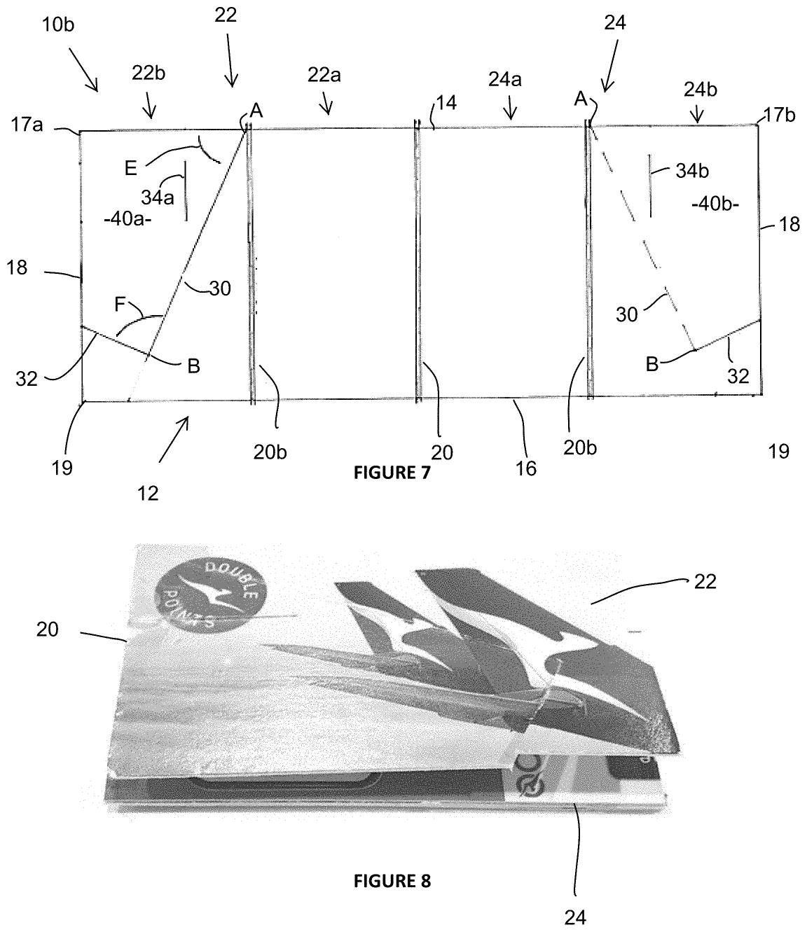

FIG. 7 shows a card item 10b according to a second preferred embodiment of the present invention. The card item 10b has similar features to the card item 10a, and also comprises an elongated rectangular panel body 12 having a top edge 14, bottom edge 16, side edges 18, top corners 17a and 17b, and bottom corners 19. The body 12 has a first fold line 20 at a mid-portion thereof extending vertically from the top edge 14 to the bottom edge 16. The fold line 20 divides the body 12 into a first panel 22 and a second panel 24.

The first panel 22 and the second panel 24 each have a third fold line 20b at respective mid-portions thereof extending vertically from the top edge 14 to the bottom edge 16. The third fold lines 20b divide the first panel 22 and the second panel 24 into respective inner sections 22a and 24a adjacent the first fold line 20, and respective outer sections 22b and 24b adjacent the respective side edges 18.

The first panel 22 and the second panel 24 each have a second fold line 30 extending from point A being at the mid-portion of the top edge 14 of each of the first panel 22 and the second panel 24, that is, at the top point of the third fold lines 20b. The second fold lines 30 respectively extend downwardly from Point A and being angled generally towards the respective bottom corners 19 of the first panel 22 and the second panel 24, but terminating at a point B spaced from the bottom edge 16 and the respective side edges 18 of the first panel 22 and the second panel 24.

The first panel 22 and the second panel 24 each have a cut line 32 extending from point B towards the respective side edge 18 thereof, the cut lines 32 being perpendicular to their respective second fold line 30. In each of the first panel 22 and the second panel 24, the second fold line 30, cut line 32 and the top corners 17, define therebetween a respective tab section 40a and 40b. In this embodiment, each tab section 40a, 40b includes a respective vertical slit cut 34a, 34b which are disposed at an upper portion thereof adjacent the second fold line 30 and top edge 14, but spaced therefrom.

As shown in FIG. 8, the first panel 22 can be folded to the second panel 24 via the first fold line 20 to the carry configuration of the card item 10b at which the folded card item 10b is the size of a typical business card.

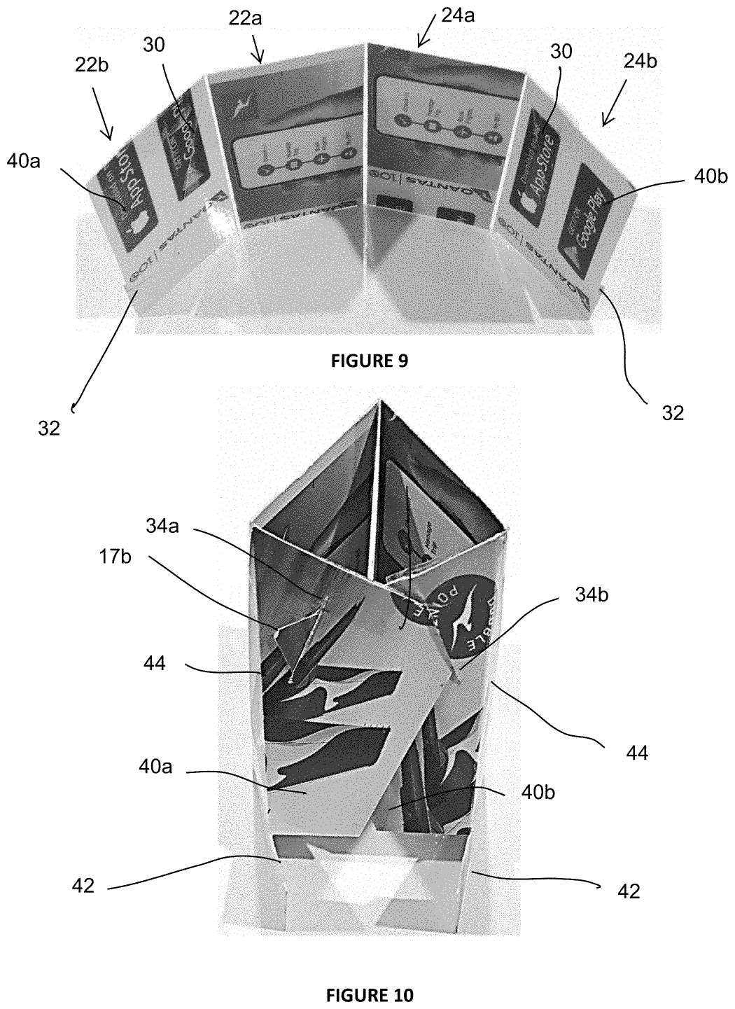

As shown in FIGS. 9 and 10, to form a smart device stand, the first panel 22 is moved to an acute angle relative to the second panel 24. The tab sections 40 are then folded inwardly, in that tab section 40a is folded towards the second panel 24 and tab section 40b is folded towards the first panel 22. Folding of the tab sections 40 reveal the seat edges 42 defined by the cut lines 32, and backrest edges 44 defined by the second fold line 30.

The top corner 17b of the second panel 24 is inserted through the slit cut 34a in the tab section 40a of the first panel 22, and the top corner 17a of the first panel 22 is inserted through the slit cut 34b in the tab section 40b of the second panel 24. This secures the card item 10b into a reinforced stand configuration thereof. The folded card item 10b forms a hollow triangular prism, with the inner sections 22a and 24a defining two sides and the joined tab sections 40a and 40b defining a third side.

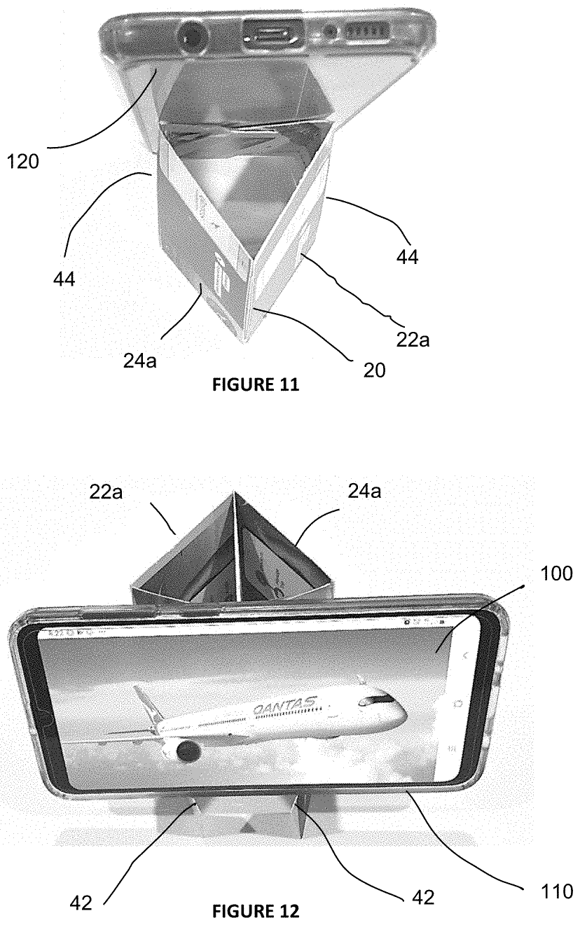

As shown in FIGS. 11 and 12, an edge 110 (either a lower edge or a side edge) of a smartphone 100 can then be placed onto the seat edges 42, with the back 120 of the smartphone 110 resting on the backrest edges 44. Portions of the outer sections 22b and 24b below the cut lines 32 define mounts for supporting the lower edge of the smart device.

In the example shown, the first panel 22 and the second panel 24 are each 110 mm in length and 90 mm in height. Point A is 55 mm from the top corners 17, second fold line 30 is 82 mm in length at a 65° angle E relative to the top edge 14, cut line 32 is at 90° angle F relative to the second fold line 30. Slit cuts 34a are spaced 20 mm from the third fold lines 20b, start from 10 mm below the top edge 14, and are 20 mm long. These dimensions are examples only and the card item 10b is not limited to these dimensions.

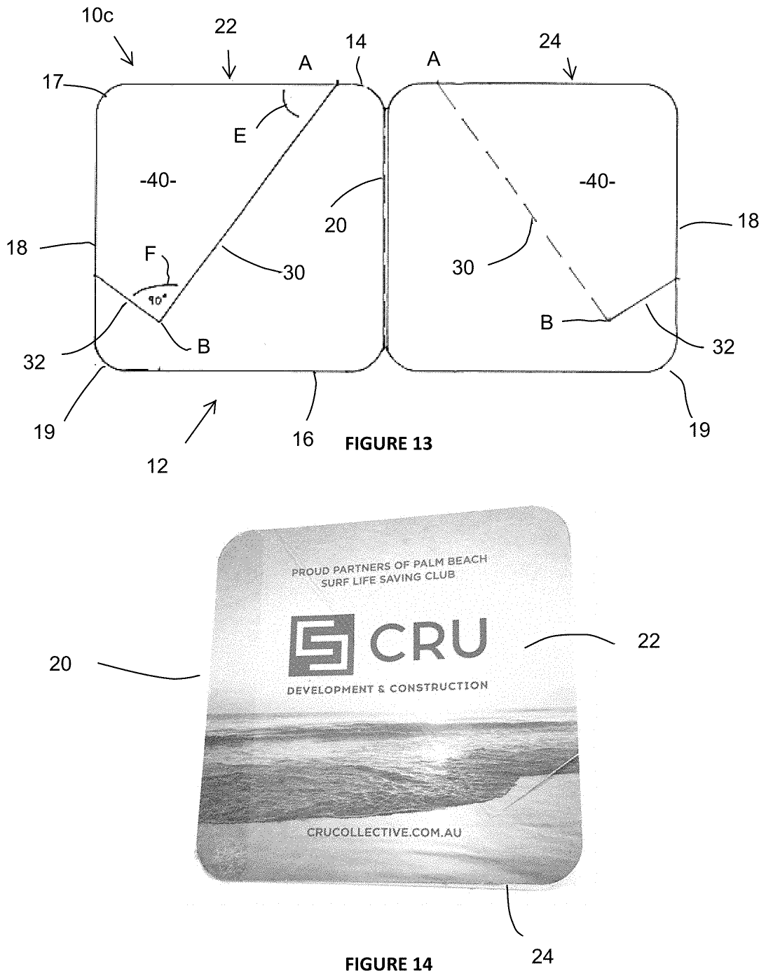

FIG. 13 shows a card item 10C according to a third preferred embodiment of the present invention. The card item 10c is similar to the card item 10a, and also comprises an elongated rectangular panel body 12 having a top edge 14, bottom edge 16, side edges 18, top corners 17 and bottom corners 19. The body 12 also has the first fold line 20 at a mid-portion thereof which divides the body 12 into a first panel 22 and a second panel 24. In this embodiment, the corners 17 and 19 are rounded and the sections of the top edge 14 and bottom edge 16 adjacent the first fold line 20 are also rounded. As shown in FIG. 14, when folded into the carry configuration, the card item 10c is shaped and dimensioned similar to a coaster.

The first panel 22 and the second panel 24 also each have the second fold line 30 extending from point A being close to the first fold line 20, the second fold lines 30 respectively extending downwardly from Point A and angled generally towards the respective bottom corners 19, but terminating at a point B spaced from the bottom edge 16 and the respective side edges 18.

The first panel 22 and the second panel 24 also each have the cut line 32 extending perpendicularly from point B towards the respective side edge 18 thereof. In each of the first panel 22 and the second panel 24, the second fold line 30, cut line 32 and the top corners 17, define therebetween the tab section 40.

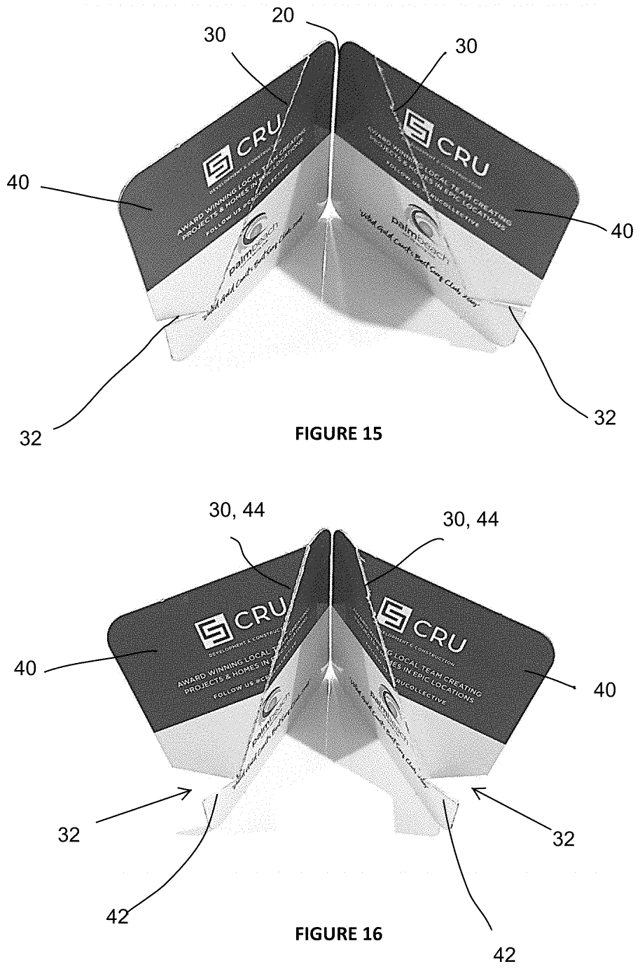

As shown in FIGS. 15 and 16, the card item 10c is folded in a similar manner as the card item 10a to form a smart device stand. The first panel 22 is moved to an acute angle relative to the second panel 24, and the tab sections 40 are folded rearwardly to reveal the seat edges 42 defined by the cut lines 32, and the backrest edges 44 defined by the second fold line 30.

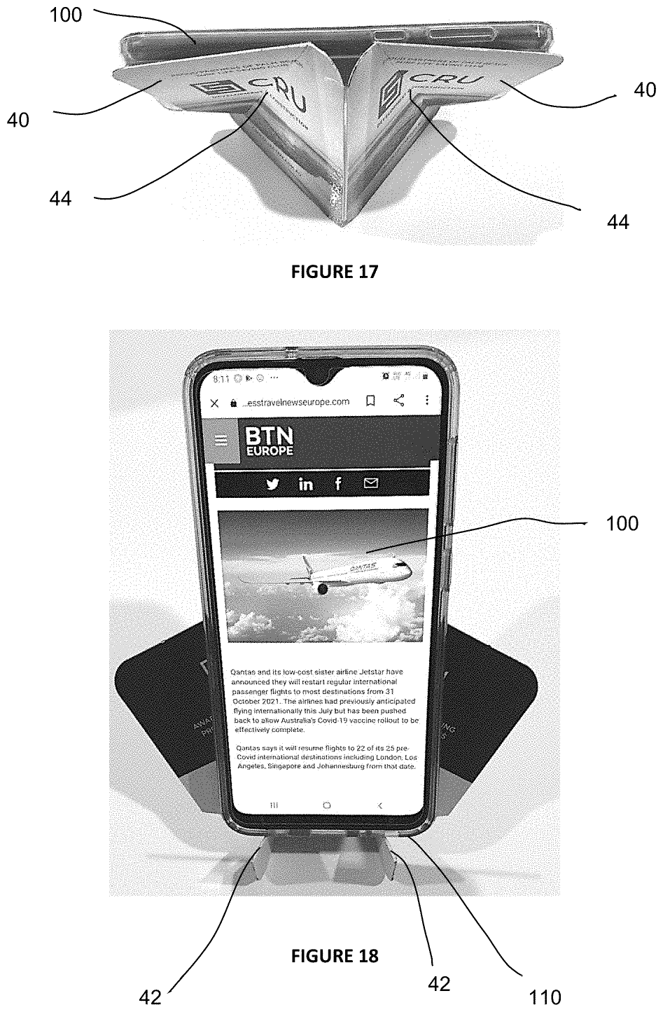

As shown in FIGS. 17 and 18, a smartphone 100 can then be placed onto the seat edges 42, with the back 120 of the smartphone 110 resting on the backrest edges 44.

In the example shown, the first panel 22 and the second panel 24 are each 95 mm in length and 95 mm in height. Point A is 80 mm from the top corners 17, second fold line 30 is 100 mm in length at a 55° angle E, cut line 32 is at 90° angle F. These dimensions are examples only.

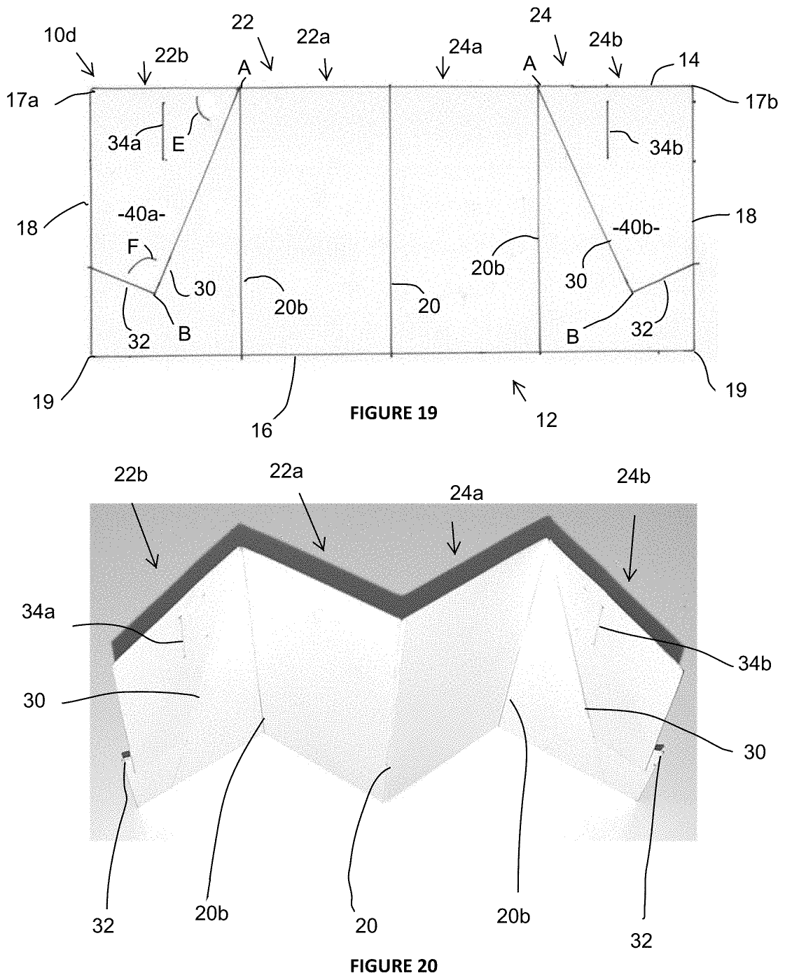

FIGS. 19 and 20 shows a card item 10d according to a fourth preferred embodiment of the present invention. The card item 10d has similar features to the card item 10b, and also comprises an elongated rectangular panel body 12 having a top edge 14, bottom edge 16, side edges 18, top corners 17a and 17b, and bottom corners 19. The body 12 also has a first fold line 20 at a mid-portion thereof which divides the body 12 into a first panel 22 and a second panel 24.

The first panel 22 and the second panel 24 also each have the third fold line 20b at respective mid-portions thereof. The third fold lines 20b divide the first panel 22 and the second panel 24 into respective inner sections 22a and 24a adjacent the first fold line 20, and respective outer sections 22b and 24b adjacent the respective side edges 18.

The first panel 22 and the second panel 24 also have the second fold line 30 extending from point A being at the mid-portion of the top edge 14 of each of the first panel 22 and the second panel 24. The second fold lines 30 respectively extend downwardly from Point A and being angled generally towards the respective bottom corners 19 of the first panel 22 and the second panel 24, terminating at point B spaced from the bottom edge 16 and the respective side edges 18 of the first panel 22 and the second panel 24.

The first panel 22 and the second panel 24 also each have the cut line 32 extending from point B towards the respective side edge 18 thereof, the cut lines 32 being perpendicular to their respective second fold line 30. In each of the first panel 22 and the second panel 24, the second fold line 30, cut line 32 and the top corners 17, define therebetween a respective tab section 40a and 40b. In this embodiment, each tab section 40a, 40b includes a respective vertical slit cut 34a, 34b which are disposed at an upper portion thereof adjacent the second fold line 30 and top edge 14, but spaced therefrom.

The first panel 22 can be folded to the second panel 24 via the first fold line 20 to the carry configuration of the card item 10d.

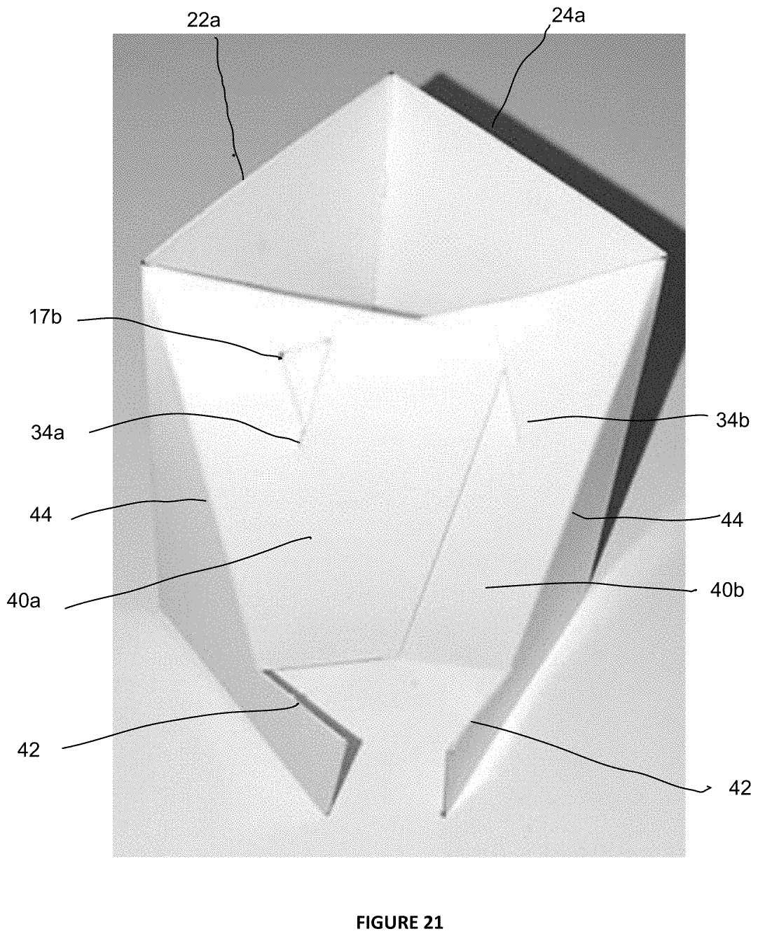

As shown in FIG. 21, to form a smart device stand, the first panel 22 is moved to an acute angle relative to the second panel 24. The tab sections 40 are then folded inwardly, in that tab section 40a is folded towards the second panel 24 and tab section 40b is folded towards the first panel 22. Folding of the tab sections 40 reveal the seat edges 42 defined by the cut lines 32, and backrest edges 44 defined by the second fold line 30.

The top corner 17b of the second panel 24 is inserted through the slit cut 34a in the tab section 40a of the first panel 22, and the top corner 17a of the first panel 22 is inserted through the slit cut 34b in the tab section 40b of the second panel 24. This secures the card item 10b into a reinforced stand configuration thereof.

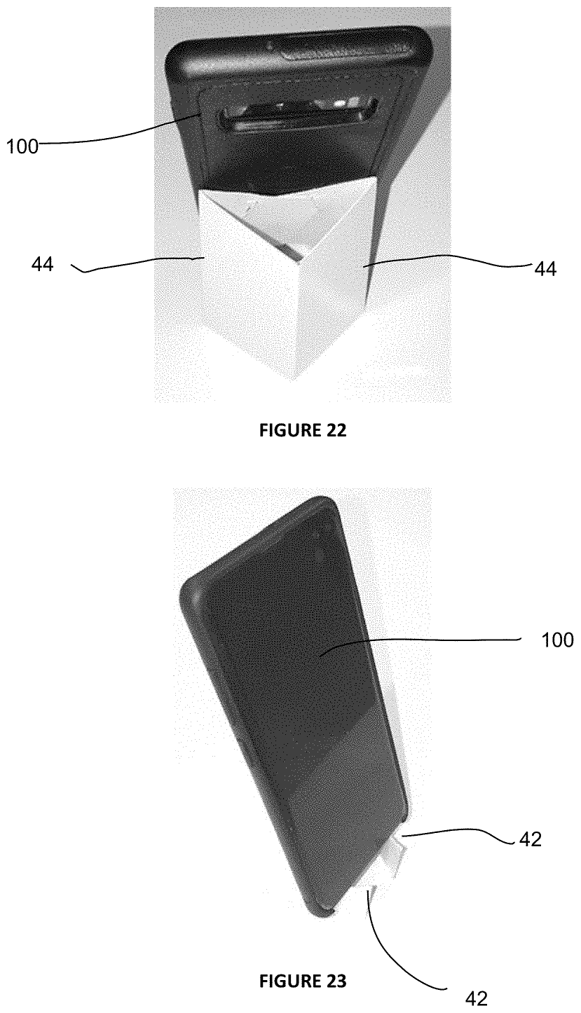

As shown in FIGS. 21 and 22, an edge 110 (either a lower edge or a side edge) of a smartphone 100 can then be placed onto the seat edges 42, with the back 120 of the smartphone 110 resting on the backrest edges 44.

In the example shown, the first panel 22 and the second panel 24 are each 105 mm in length and 90 mm in height. Point A is 52.5 mm from the top corners 17, second fold line 30 is 82 mm in length at a 65° angle E relative to the top edge 14, cut line 32 is at 90° angle F relative to the second fold line 30. Slit cuts 34a are spaced 27.5 mm from the third fold lines 20b, start from 5 mm below the top edge 14, and are 20 mm long. These dimensions are examples only.

The invention thus provides embodiments of a disposable and reusable mobile phone holder. The examples shown can be made from laminated carboard, easy to transport and construct, and can be a single or multiple use product. The card items can be printed with advertising and information for use in planes, cafes, conferences, pubs, universities, food and drink places, when taking notes, where the user needs a stand for their smartphone playing a video, movie, watching sport, etc.

The example products are dimensioned similar to business cards, coasters, and the like, and can have branding, advertising, promotions, special deals, etc printed thereon.

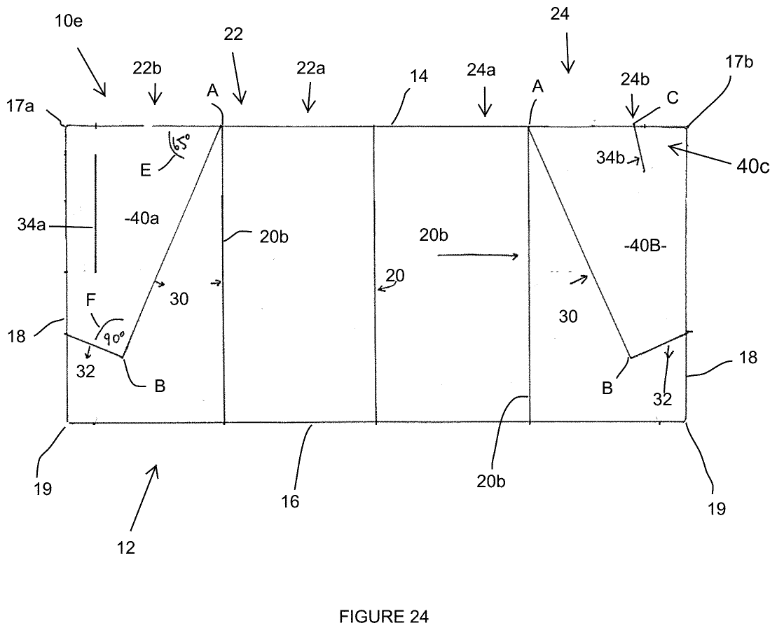

FIG. 24 shows a card item 10e according to a fifth preferred embodiment of the present invention. The card item 10e has similar features to the card item 10b, and also comprises an elongated rectangular panel body 12 having a top edge 14, bottom edge 16, side edges 18, top corners 17a and 17b, and bottom corners 19. The body 12 has a first fold line 20 at a mid-portion thereof extending vertically from the top edge 14 to the bottom edge 16. The fold line 20 divides the body 12 into a first panel 22 and a second panel 24.

The first panel 22 and the second panel 24 each have a third fold line 20b at respective mid-portions thereof extending vertically from the top edge 14 to the bottom edge 16. The third fold lines 20b divide the first panel 22 and the second panel 24 into respective inner sections 22a and 24a adjacent the first fold line 20, and respective outer sections 22b and 24b adjacent the respective side edges 18.

The first panel 22 and the second panel 24 each have a second fold line 30 extending from point A being at the mid-portion of the top edge 14 of each of the first panel 22 and the second panel 24, that is, at the top point of the third fold lines 20b. The second fold lines 30 respectively extend downwardly from Point A and being angled generally towards the respective bottom corners 19 of the first panel 22 and the second panel 24, but terminating at a point B spaced from the bottom edge 16 and the respective side edges 18 of the first panel 22 and the second panel 24.

The first panel 22 and the second panel 24 each have a cut line 32 extending from point B towards the respective side edge 18 thereof, the cut lines 32 being perpendicular to their respective second fold line 30. In each of the first panel 22 and the second panel 24, the second fold line 30, cut line 32 and the top corners 17, define therebetween a respective tab section 40a and 40b. In this embodiment, the tab section 40a includes a vertical slit cut 34a which is disposed at an upper portion thereof parallel to the side edge 18, adjacent the side edge 18 and the top edge 14, but spaced therefrom. The tab section 40b includes a slit cut 34b extending from the top edge 14 from a point C spaced from the top corner 17b and angled towards the bottom corner 19 of the panel 24. Point C is located between ¼ to ⅓ the distance between top corner 17b and point A. Slit cut 34a in the example is about 40 mm long and slit cut 34b is about 15 mm long.

Similar to the card item 10b, the first panel 22 can be folded to the second panel 24 via the first fold line 20 to the carry configuration of the card item 10b at which the folded card item 10b is the size of a typical business card. To form a smart device stand, the first panel 22 is moved to an acute angle relative to the second panel 24. The tab sections 40 are then folded inwardly, in that tab section 40a is folded towards the second panel 24 and tab section 40b is folded towards the first panel 22. Folding of the tab sections 40 reveal the seat edges 42 defined by the cut lines 32, and backrest edges 44 defined by the second fold line 30.

The top corner 17b of the second panel 24 is inserted through the slit cut 34a in the tab section 40a of the first panel 22, with the slit cut 34b in the tab section 40b of the second panel 24 assisting with this insertion by having the top corner portion 40c of the tab section 40b being pivotable. The pivotable top corner portion 40c assists with the ease of assembly into the stand configuration. This secures the card item 10b into a reinforced stand configuration thereof. The folded card item 10b forms a hollow triangular prism, with the inner sections 22a and 24a defining two sides and the joined tab sections 40a and 40b defining a third side.

An edge 110 (either a lower edge or a side edge) of a smartphone 100 can then be placed onto the seat edges 42, with the back 120 of the smartphone 110 resting on the backrest edges 44. Portions of the outer sections 22b and 24b below the cut lines 30 define mounts for supporting the lower edge of the smart device.

In the example shown, the first panel 22 and the second panel 24 are each 105 mm in length and 100 mm in height. Point A is 52.5 mm from the top corners 17, second fold line 30 is 80 mm in length at a 65° angle E relative to the top edge 14, cut line 32 is at 90° angle F relative to the second fold line 30. Slit cut 34a is spaced 10 mm from the side edge 18 and 10 mm from the top edge 14 and is 40 mm long. Slit cut 34b is spaced 15 mm from the top corner 17b and is about 15 mm in length. These dimensions are examples only and the card item 10b is not limited to these dimensions.

Whilst preferred embodiments of the present invention have been described, it will be apparent to skilled persons that modifications can be made to the embodiments described. For example, the product can be dimensioned to be a stand for a tablet device such as an iPad.

1. A card item foldable into a smart device stand, the card item comprising:
a panel body having a first fold line at a mid-portion thereof to define a first panel and a second panel,
wherein the first panel and the second panel each have a second fold line extending from a top edge and a cut line extending from the second fold line to an outer edge,
wherein in each of the first panel and the second panel, the second fold line, the cut line and a respective top corner define a tab section, and
wherein the first panel can be folded towards the second panel and the tab sections can be folded to reveal seat edges defined by the cut lines and backrest edges defined by the second fold lines.

2. The card item of claim 1, wherein the tab sections are folded rearwardly.

3. The card item of claim 1, wherein the tab sections are folded towards each other.

4. The card item of claim 3, wherein the tab sections are connected to each other.

5. The card item of clam 4, wherein the first panel and the second panel each have a respective third fold line to define inner panel sections and outer panel sections, the outer panel sections having the tab sections, wherein the outer panel sections are folded towards each other.

6. The card item of claim 1, further comprising:
a rectangular panel body having a top edge, bottom edge, side edges, top corners and bottom corners, and the first fold line extends vertically from the top edge to the bottom edge at a mid-portion thereof.

7. The card item of claim 6, wherein the second fold line extends from about a mid-portion of the top edge of each of the first panel and the second panel, the second fold lines respectively extending downwardly and being angled generally towards the respective bottom corners of the first panel and the second panel, the second fold lines terminating at a cut point spaced from the bottom edge and the respective side edges of the first panel and the second panel.

8. The card item of claim 7, wherein the cut lines extend from the cut point towards the respective side edge thereof, the cut lines being substantially perpendicular to their respective second fold line.

9. The card item of claim 1, wherein the first panel can be folded to the second panel via the first fold line to a carry configuration of the card item.

10. The card item of claim 5, wherein the third fold lines are disposed at respective mid-portions of the first panel and the second panel and extend vertically from the top edge to the bottom edge.

11. The card item of claim 4, wherein each tab section includes a respective vertical slit cut disposed at an upper portion thereof and a top corner of the second panel can be inserted through the slit cut in the tab section of the first panel, and the top corner of the first panel can be inserted through the slit cut in the tab section of the second panel.

12. The card item of claim 1, wherein the first panel and the second panel are generally square panels with rounded corners and the second fold line extends from close to the first fold line.

13. The card item of claim 1, wherein the tab section of the first panel is comprised of a vertical slit cut which is disposed at an upper portion thereof parallel to the side edge and spaced from the top edge, and wherein the tab section of the second panel is comprised of a slit cut extending from the top edge thereof and spaced from the top corner thereof to form a pivotable top corner portion.
